(19) United States
(12) Patent Application Publication
(10) Pub. No.: US 2012/0314966 A1
(43) Pub. Date: Dec. 13, 2012

(54) IMAGE CODING APPARATUS, IMAGE DECODING APPARATUS, IMAGE CODING METHOD, IMAGE DECODING METHOD, AND PROGRAM

(75) Inventor: Yuji WADA, Tokyo (JP)

(73) Assignee: Sony Corporation, Tokyo (JP)

(21) Appl. No.: 13/442,199

(22) Filed: Apr. 9, 2012

(30) Foreign Application Priority Data
Jun. 7, 2011 (JP) 2011-127183

(51) Int. Cl. G06K 9/36

(52) U.S. Cl. 382/233

(57) ABSTRACT

An image coding apparatus includes: a coding processor that codes an image representing a difference between an input image and a predicted image to generate coded data; a decoding processor that decodes the coded data to generate a local decoded image; a local decoded image coder that codes the local decoded image and stores the coded local decoded image in a memory; a local decoded image decoder that decodes the local decoded image coded and stored in the memory; and a controller that controls the generation of the coded data in accordance with coding distortion information representing the degree of coding distortion produced in the coding/decoding of the local decoded image.

### FIELD

The present technology relates to an image coding apparatus, an image decoding apparatus, an image coding method, an image decoding method, and a program. Specifically, the present technology aims to increase encoding efficiency when a local decoded image is stored and still perform decoding to provide a high-quality decoded image.

### BACKGROUND

In recent years, apparatus that handle digital image information and efficiently transmit and accumulate the information have been widely used. Apparatus of this type comply, for examples, with MPEG2 (ISO/IEC13818-2) or H.264/AVC (advanced video coding). In MPEG and other similar coding methods based on interframe correlation, an image referred to for motion compensation, for example, a local decoded image that is formed based on one frame before an image of interest, is temporarily stored in a memory or any other storage device.

On the other hand, a memory or any other storage device is subject to constraints on capacity and data bandwidth (amount of readable/writable data per second), and the cost of the memory can be lower by using a memory having a smaller data capacity and a lower bandwidth. In view of the fact, JP-A-2010-135885 and JP-A-10-271516 propose technologies for coding a local decoded image and storing the coded image in a storage device.

### SUMMARY

Coding is classified into lossless coding and lossy coding. Lossy coding, in which the coding efficiency is higher than in lossless coding because data loss is accepted, allows the amount of data and bandwidth and hence the cost to be reduced. However, when a local decoded image is coded based on lossy coding, which accepts data loss, a coding apparatus that does not use the same lossy coding compression can cause degradation in quality of a decoded image at the time of decoding.

It is therefore desirable to provide an image coding apparatus, an image decoding apparatus, an image coding method, an image decoding method, and a program capable of increasing coding efficiency when a local decoded image is stored and still performing decoding to provide a high-quality decoded image.

An embodiment of the present technology is directed to an image coding apparatus including a coding processor that codes an image representing a difference between an input image and a predicted image to generate coded data, a decoding processor that decodes the coded data to generate a local decoded image, a local decoded image coder that codes the local decoded image and stores the coded local decoded image in a memory, a local decoded image decoder that decodes the local decoded image coded and stored in the memory, and a controller that controls the generation of the coded data in accordance with coding distortion information representing the degree of coding distortion produced in the coding/decoding of the local decoded image.

In the embodiment of the present technology described above, an image representing the difference between an input image and a predicted image is coded to generate coded data. The coded data is decoded to generate a local decoded image, which is coded and stored in a memory. The local decoded image coded and stored in the memory is decoded, and the decoded local decoded image is used to generate the predicted image. A quantization parameter used to code the difference image is, for example, adjusted in accordance with coding distortion information representing the degree of coding distortion produced in the coding/decoding of the local decoded image in such a way that an effect of the coding distortion is reduced. Further, the range of the quantization parameter is limited in accordance with the coding distortion information, and the quantization parameter is coded by using the limited range. Moreover, the strength of the filtering of the deblocking filter is changed and the intra-prediction image or the inter-prediction image is chosen in accordance with the coding distortion information.

Another embodiment of the present technology is directed to an image coding method including coding an image representing a difference between an input image and a predicted image to generate coded data, decoding the coded data to generate a local decoded image, coding the local decoded image and storing the coded local decoded image in a memory, decoding the local decoded image coded and stored in the memory, and controlling the generation of the coded data in accordance with coding distortion information representing the degree of coding distortion produced in the coding/decoding of the local decoded image.

Still another embodiment of the present technology is directed to a program that instructs a computer to execute coding an image representing a difference between an input image and a predicted image to generate coded data, decoding the coded data to generate a local decoded image, coding the local decoded image and storing the coded local decoded image in a memory, decoding the local decoded image coded and stored in the memory, and controlling the generation of the coded data in accordance with coding distortion information representing the degree of coding distortion produced in the coding/decoding of the local decoded image.

Yet another embodiment of the present technology is directed to an image decoding apparatus including a decoding processor that decodes a coded stream to generate a difference image and adds a predicted image to the difference image to generate a decoded image, a local decoded image coder that codes the decoded image as a local decoded image and stores the local decoded image in a memory, a local decoded image decoder that decodes the local decoded image coded and stored in the memory, and a controller that controls the generation of the difference image or the predicted image in accordance with coding distortion information representing the degree of coding distortion produced in the coding/decoding of the local decoded image.

In the embodiment of the present technology, a coded stream is decoded to generate a difference image, and a predicted image is added to the difference image to generate a decoded image. The decoded image is coded as a local decoded mage, which is stored in a memory. The local decoded image coded and stored in the memory is decoded, and the decoded local decoded image is used to generate the predicted image. The range of the quantization parameter is, for example, limited in accordance with coding distortion information representing the degree of coding distortion produced in the coding/decoding of the local decoded image, and the quantization parameter coded and added to the coded stream is decoded by using the limited range, whereby the decoded quantization parameter is used to decode the coded stream to generate the difference image. Further, the strength of the filtering of the deblocking filter is changed in accordance with the coding distortion information. Moreover, an intra-prediction image or an inter-prediction image is chosen in accordance with the coding distortion information, and the chosen image is used as the predicted image.

Still yet another embodiment of the present technology is directed to an image decoding method including decoding a coded stream to generate a difference image and adding a predicted image to the difference image to generate a decoded image, coding the decoded image as a local decoded image and storing the local decoded image in a memory, decoding the local decoded image coded and stored in the memory, and controlling the generation of the difference image or the predicted image in accordance with coding distortion information representing the degree of coding distortion produced in the coding/decoding of the local decoded image.

Further another embodiment of the present technology is directed to a program that instructs a computer to execute decoding a coded stream to generate a difference image and adding a predicted image to the difference image to generate a decoded image, coding the decoded image as a local decoded image and storing the local decoded image in a memory, decoding the local decoded image coded and stored in the memory, and controlling the generation of the difference image or the predicted image in accordance with coding distortion information representing the degree of coding distortion produced in the coding/decoding of the local decoded image.

The program according to the embodiment of the present technology can, for example, be used in a general-purpose computer that can execute a variety of program codes via a storage medium or a communication medium provided in a computer-readable form, such as an optical disk, a magnetic disk, a semiconductor memory, and other similar storage media, or a network and other communication media. When the program is provided in a computer-readable form, processes according to the program are carried out in the computer.

According to the embodiments of the present technology, at the time of coding, coded data generated by coding information on the difference between an input image and a predicted image is decoded to generate a local decoded image. The local decoded image is coded and stored in a memory and then read and decoded. The generation of the coded data is controlled in accordance with coding distortion produced in the coding/decoding of the local decoded image, whereby an effect of the coding distortion is reduced. Further, when a coded stream is decoded, a decoded image generated in the decoding process is coded as a local decoded image and stored in a memory and then read and decoded. The generation of the decoded image is also controlled in accordance with coding distortion produced in the coding/decoding of the local decoded image, as in the coding process. A high-quality decoded image can be provided at the time of decoding even when coding efficiency is increased when a local decoded image is stored.

### BRIEF DESCRIPTION OF THE DRAWINGS

FIG. 1 shows the configuration of an image coding apparatus;

FIG. 2 is a flowchart showing the operation of the image coding apparatus;

FIG. 3 is a flowchart showing quantization parameter limiting operation;

FIG. 4 shows the configuration of an image decoding apparatus; and

FIG. 5 is a flowchart showing the operation of the image decoding apparatus.

### DETAILED DESCRIPTION

An embodiment of the present technology will be describe below. The description will be made in the following order.

1. Configuration of image coding apparatus

2. Operation of image coding apparatus

3. Operation of adjusting quantization parameter

4. Operation of limiting quantization parameter

5. Other operations of reducing effect of coding distortion

6. Configuration of image decoding apparatus

7. Operation of image decoding apparatus

8. Decoding operation performed when quantization parameter is limited

9. Decoding operation performed when effect of coding distortion is reduced at the time of coding

10. Using software processing

### <1. Configuration of Image Coding Apparatus>

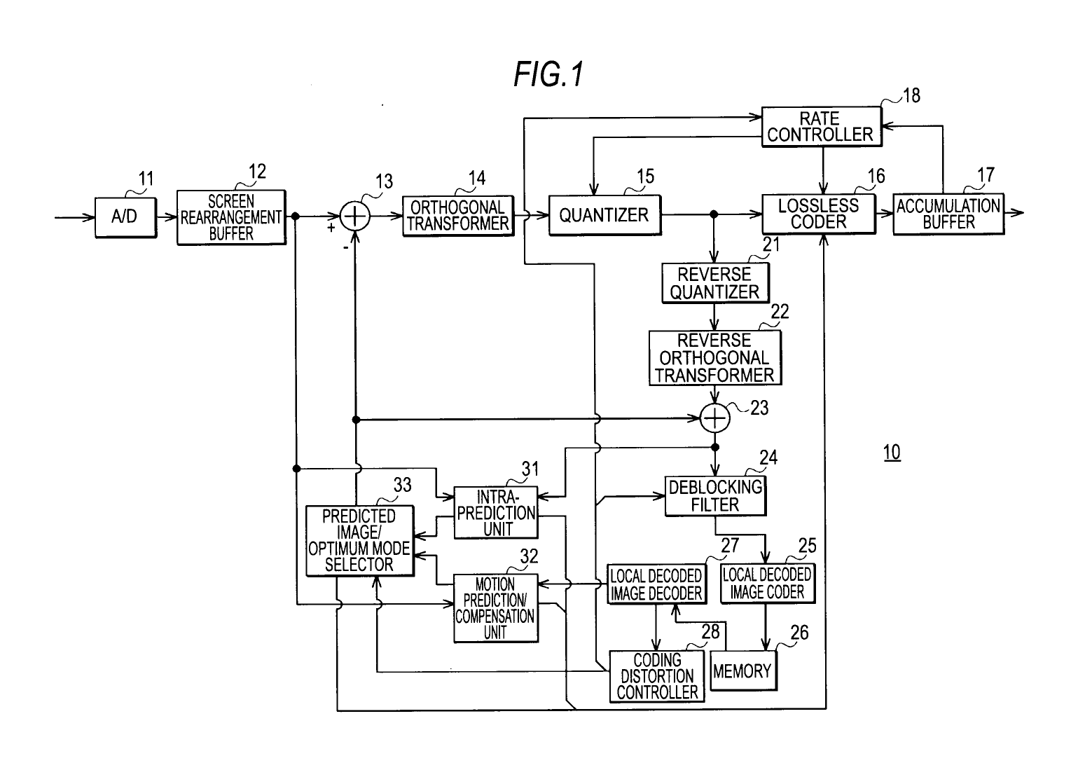

FIG. 1 shows the configuration of an image coding apparatus. An image coding apparatus 10 includes an analog/digital converter (A/D converter) 11, a screen rearrangement buffer 12, a subtractor 13, an orthogonal transformer 14, a quantizer 15, a lossless coder 16, an accumulation buffer 17, and a rate controller 18. The image coding apparatus 10 further includes a reverse quantizer 21, a reverse orthogonal transformer 22, an adder 23, a deblocking filter 24, a local decoded image coder 25, a memory 26, a local decoded image decoder 27, a coding distortion controller 28, an intra-prediction unit 31, a motion prediction/compensation unit 32, and a predicted image/optimum mode selector 33.

The A/D converter 11 converts an analog image signal into digital image data and outputs the image data to the screen rearrangement buffer 12.

The screen rearrangement buffer 12 rearranges frames based on the image data outputted from the A/D converter 11. The screen rearrangement buffer 12 rearranges the frames in accordance with a coding-related GOP (group of pictures) structure and outputs the rearranged image data to the subtractor 13, the rate controller 18, the intra-prediction unit 31, and the motion prediction/compensation unit 32.

The subtractor 13 receives the image data outputted from the screen rearrangement buffer 12 and predicted image data selected by the predicted image/optimum mode selector 33, which will be described later. The subtractor 13 calculates image data on a difference image (predicted error data) that is the difference between image data on an input image outputted from the screen rearrangement buffer 12 and image data on an predicted image supplied from the predicted image/optimum mode selector 33 and outputs the calculated image data to the orthogonal transformer 14.

The orthogonal transformer 14 performs discrete cosine transform (DCT), Karhunen-Loeve transform, or any other suitable orthogonal transform of the predicted error data outputted from the subtractor 13. The orthogonal transformer outputs transform coefficient data provided in the orthogonal transform to the quantizer 15.

The quantizer 15 receives the transform coefficient data outputted from the orthogonal transformer 14 and a quantization parameter (quantization scale) from the rate controller 18, which will be described later. The quantizer 15 quantizes the transform coefficient data and outputs the quantized data to the lossless coder 16 and the reverse quantizer 21. The quantizer 15 further changes the bit rate of the quantized data in accordance with the quantization parameter set by the rate controller 18.

The lossless coder 16 receives the quantized data from the quantizer 15, prediction mode information from the intra-prediction unit 31, prediction mode information and motion vector information from the motion prediction/compensation unit 32, and other pieces of information. The lossless coder 16 further receives information representing whether an optimum mode is intra-prediction or inter-prediction from the predicted image/optimum mode selector 33. The prediction mode information includes information on a prediction mode, block size, and other parameters depending on whether the optimum mode is intra-prediction or inter-prediction.

The lossless coder 16 performs variable-length coding, arithmetic coding, or any other suitable lossless coding of the quantized data to generate a coded stream and outputs the coded stream to the accumulation buffer 17. When the optimum mode is intra-prediction, the lossless coder 16 performs lossless coding of the predicted mode information supplied from the intra-prediction unit 31. When the optimum mode is inter-prediction, the lossless coder 16 performs lossless coding of the prediction mode information, motion vector information, and other pieces of information supplied from the motion prediction/compensation unit 32. The lossless coder 16 further performs lossless coding of information on the quantization parameter. The lossless coder 16 adds the information having undergone the lossless coding to the coded stream. For example, the lossless coder 16 adds the information to a header of the coded stream.

The accumulation buffer 17 accumulates the coded stream from the lossless coder 16. The accumulation buffer 17 further outputs the accumulated coded stream at a transmission rate according to a transmission path.

The rate controller 18 monitors a free space of the accumulation buffer 17, sets the quantization parameter in such a way that the bit rate of the quantized data is lowered when the free space is small whereas the bit rate of the quantized data is raised when the free space is sufficiently large, and outputs the thus set quantization parameter to the quantizer 15. The rate controller 18 further adjusts and limits the quantization parameter in accordance with coding distortion information in response to a control signal from the coding distortion controller 28, which will be described later. The rate controller 18 may supply the lossless coder 16 with information on the limited quantization parameter in order to increase the efficiency at which the quantization parameter information is coded. The coding distortion controller 28 may alternatively supply the lossless coder 16 with the information on the limited quantization parameter.

The reverse quantizer 21 performs reverse quantization of the quantized data supplied from the quantizer 15. The reverse quantizer 21 outputs the transform coefficient data obtained in the reverse quantization to the reverse orthogonal transformer 22.

The reverse orthogonal transformer 22 performs reverse orthogonal transform of the transform coefficient data supplied from the reverse quantizer 21 and outputs the resultant data to the adder 23.

The adder 23 adds the data supplied from the reverse orthogonal transformer 22 to the predicted image data supplied from the predicted image/optimum mode selector 33 to generate image data on a local decoded image and outputs the local decoded image to the deblocking filter 24 and the intra-prediction unit 31. The local decoded image generated by the adder 23 is used as a reference image in intra-prediction or inter-prediction.

The deblocking filter 24 performs filtering for reducing block distortion produced when an image is coded. The deblocking filter 24 performs filtering for removing the block distortion from the image data supplied from the adder 23 and outputs the filtered image data to the local decoded image coder 25. The deblocking filter 24 adjusts the strength of the filtering in accordance with coding distortion information in response to a control signal from the coding distortion controller 28, which will be described later.

The local decoded image coder 25 codes the image data filtered by the deblocking filter 24 based on lossy coding and outputs the coded image data to the memory 26. The local decoded image coder 25 further outputs the coding distortion information representing the degree of coding distortion to the memory 26. The amount of data to be stored in the memory 26 can be reduced by coding the coding distortion information in the local decoded image coder 25 before it outputs the coding distortion information to the memory 26. A Q number (quality number) is used as the coding distortion information when image data is coded based, for example, on JPEG (Joint Photographic Experts Group). When image data is coded based on bit plane coding, information on a bit disposal position is used as the coding distortion information.

The memory 26 holds the coded data and the coding distortion information corresponding thereto supplied from the local decoded image coder 25. The coded data and the coding distortion information corresponding thereto read from the memory 26 are outputted to the local decoded image decoder 27.

The local decoded image decoder 27 decodes the coded data supplied from the memory 26 and supplies the motion prediction/compensation unit 32 with the resultant image data as reference image data. The local decoded image decoder 27 further outputs the coding distortion information read from the memory 26 to the coding distortion controller 28. When the coding distortion information has been coded, the local decoded image decoder 27 decodes the coding distortion information.

The coding distortion controller 28 controls the generation of the coded data to reduce an effect of the coding distortion by generating control signals based on the coding distortion information and outputting the control signals to the rate controller 18, the deblocking filter 24, and the predicted image/optimum mode selector 33.

The intra-prediction unit 31 uses input image data on an image to be coded supplied from the screen rearrangement buffer 12 to perform prediction in all or part of candidate intra-prediction modes to determine an optimum intra-prediction mode. The intra-prediction unit 31, for example, calculates a cost function value in each of the intra-prediction modes and determines, based on the calculated cost function value, an optimum intra-prediction mode as an intra-prediction mode in which the coding efficiency is maximized. The intra-prediction unit 31 outputs predicted image data generated in the optimum intra-prediction mode and a cost function value in the optimum intra-prediction mode to the predicted image/optimum mode selector 33. The intra-prediction unit 31 further outputs prediction mode information representing the optimum intra-prediction mode to the lossless coder 16.

The motion prediction/compensation unit 32 uses the input image data on the image to be coded supplied from the screen rearrangement buffer 12 and the reference image data supplied from the memory 26 to perform, for example, motion prediction in all or part of candidate inter-prediction modes to determine an optimum inter-prediction mode. The motion prediction/compensation unit 32, for example, calculates a cost function value in each of the inter-prediction modes and determines, based on the calculated cost function value, an optimum inter-prediction mode as an inter-prediction mode in which the coding efficiency is maximized. The motion prediction/compensation unit 32 outputs predicted image data generated in the optimum inter-prediction mode and the cost function value in the optimum inter-prediction mode to the predicted image/optimum mode selector 33. The motion prediction/compensation unit 32 further outputs prediction mode information on the optimum inter-prediction mode and motion vector information to the lossless coder 16.

The predicted image/optimum mode selector 33 compares the cost function value supplied from the intra-prediction unit 31 with the cost function value supplied from the motion prediction/compensation unit 32 and chooses the smaller cost function value as an optimum mode in which the coding efficiency is maximized. The predicted image/optimum mode selector 33 further outputs the predicted image data generated in the optimum mode to the subtractor 13 and the adder 23. The predicted image/optimum mode selector 33 further outputs information representing whether the optimum mode is an intra-prediction mode or an inter-prediction mode to the lossless coder 16. The predicted image/optimum mode selector 33 switches the prediction mode between the intra-prediction and the inter-prediction on a slice basis. The predicted image/optimum mode selector 33 further specifies the optimum mode based on the coding distortion information in response to the control signal from the coding distortion controller 28. The predicted image/optimum mode selector 33 may alternatively select an optimum mode in the intra-prediction unit 31 based on the signal from the coding distortion controller 28.

As described above, in the image coding apparatus 10, the intra-prediction unit 31, the motion prediction/compensation unit 32, and the predicted image/optimum mode selector 33 generate a predicted image. The subtractor 13, the orthogonal transformer 14, the quantizer 15, the lossless coder 16, the accumulation buffer 17, and the rate controller 18 process the generated predicted image and an input image to generate coded data. Further, in the image coding apparatus 10, the reverse quantizer 21, the reverse orthogonal transformer 22, and the adder 23 generate a local decoded image.

### <2. Operation of Image Coding Apparatus>

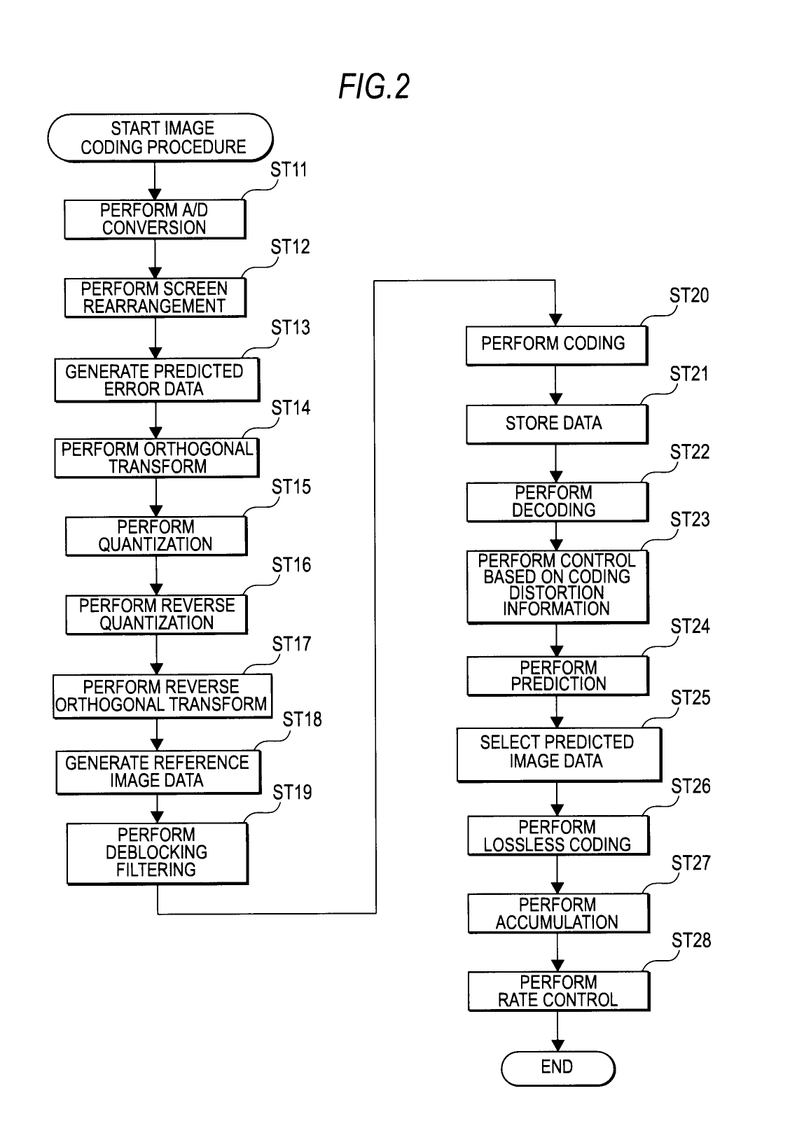

The operation of the image coding apparatus will next be described with reference to the flowchart shown in FIG. 2. In step ST11, the A/D converter 11 A/D converts an input image signal.

In step ST12, the screen rearrangement buffer 12 performs image rearrangement. The screen rearrangement buffer 12 stores image data supplied from the A/D converter 11 and performs rearrangement by which the order in which pictures are displayed is changed to the order in which the pictures are coded.

In step ST13, the subtractor 13 generates predicted error data. The subtractor 13 calculates the difference between the image data on an input image rearranged in step ST12 and image data on a predicted image selected by the predicted image/optimum mode selector 33 to generate image data on the difference image, that is, predicted error data. The amount of predicted error data is smaller than the amount of original image data. The amount of data can therefore be reduced than in a case where an image is directly coded.

In step ST14, the orthogonal transformer 14 performs orthogonal transform. The orthogonal transformer 14 performs orthogonal transform of the predicted error data supplied from the subtractor 13. Specifically, the orthogonal transformer performs discrete cosine transform, Karhunen-Loeve transform, or any other suitable orthogonal transform of the predicted error data and outputs transform coefficient data.

In step ST15, the quantizer 15 performs quantization. The quantizer 15 quantizes the transform coefficient data. In the quantization, rate control is performed, as will be described later in the process in step ST28.

In step ST16, the reverse quantizer 21 performs reverse quantization. The reverse quantizer 21 performs reverse quantization of the transform coefficient data, which has been quantized by the quantizer 15, based on characteristics corresponding to the characteristics of the quantizer 15.

In step ST17, the reverse orthogonal transformer 22 performs reverse orthogonal transform. The reverse orthogonal transformer 22 performs reverse orthogonal transform of the transform coefficient data, which has been reverse quantized by the reverse quantizer 21, based on characteristics corresponding to the characteristics of the orthogonal transformer 14.

In step ST18, the adder 23 generates reference image data. The adder 23 adds predicted image data supplied from the predicted image/optimum mode selector 33 to the data having undergone the reverse orthogonal transform in a position corresponding to the predicted image to generate image data on a local decoded image (reference image data).

In step ST19, the deblocking filter 24 performs filtering. The deblocking filter 24 filters the image data outputted from the adder 23 to remove block distortion.

In step ST20, the local decoded image coder 25 codes the image data filtered by the deblocking filter 24. The local decoded image coder 25 codes the image data based on lossy coding using high coding efficiency and outputs the coded image data. The local decoded image coder 25 further generates coding distortion information representing the degree of coding distortion and outputs the coding distortion information. The amount of data outputted from the local decoded image coder 25 can be reduced by coding the coding distortion information.

In step ST21, the memory 26 stores the data. The memory stores the coded image data and coding distortion information outputted from the local decoded image coder 25.

In step ST22, the local decoded image decoder 27 performs decoding. The local decoded image decoder 27 decodes the coded data read from the memory 26. The local decoded image decoder 27 further decodes the coding distortion information when the coding distortion information read from the memory 26 has been coded.

In step ST23, the coding distortion controller 28 performs control based on the coding distortion information. The coding distortion controller 28 generates a control signal based on the coding distortion information and outputs the control signal to the rate controller 18, the deblocking filter 24, and the predicted image/optimum mode selector 33 to reduce an effect of coding distortion produced in the coding/decoding processes.

In step ST24, the intra-prediction unit 31 and the motion prediction/compensation unit 32 perform respective prediction operations. That is, the intra-prediction unit 31 performs intra-prediction in an intra-prediction mode, and the motion prediction/compensation unit 32 performs motion prediction/compensation in an inter-prediction mode. In the prediction operations, prediction operations in all candidate prediction modes are performed, and cost function values in all the candidate prediction modes are calculated. An optimum intra-prediction mode and an optimum inter-prediction mode are selected based on the calculated cost function values, and a predicted image and the cost function value thereof generated in the selected prediction mode and prediction mode information are supplied to the predicted image/optimum mode selector 33.

In step ST25, the predicted image/optimum mode selector 33 selects predicted image data. The predicted image/optimum mode selector 33 determines an optimum mode in which the coding efficiency is maximized based on the cost function values outputted from the intra-prediction unit 31 and the motion prediction/compensation unit 32. The predicted image/optimum mode selector 33 selects the optimum intra-prediction mode as the optimum mode based on the control signal from the coding distortion controller 28 when the image quality is greatly degraded in the coding/decoding processes. The predicted image/optimum mode selector 33 further outputs predicted image data in the thus determined optimum mode to the subtractor 13 and the adder 23. The predicted image data is used in the computation in steps ST13 and ST18, as described above.

In step ST26, the lossless coder 16 performs lossless coding. The lossless coder 16 codes the quantized data outputted from the quantizer 15 in a lossless manner. That is, the lossless coder 16 performs variable-length coding, arithmetic coding, or any other suitable lossless coding of the quantized data to generate coded data. The lossless coder 16 further codes the prediction mode information corresponding to the predicted image data selected in step ST25 and other pieces of information in a lossless manner and adds the losslessly coded data on the prediction mode information and other pieces of information to the coded stream generated by coding the quantized data in a lossless manner.

In step ST27, the accumulation buffer 17 performs accumulation. The accumulation buffer 17 accumulates the coded stream outputted from the lossless coder 16. The coded stream accumulated by the accumulation buffer 17 is read as appropriate and transmitted through a transmission path for decoding.

In step ST28, the rate controller 18 performs rate control. When the accumulation buffer 17 accumulates the coded stream, the rate controller 18 controls the rate of the quantization by setting a quantization parameter QP and outputting the quantization parameter QP to the quantizer 15 in such a way that no overflow or underflow occurs in the accumulation buffer 17. The rate controller 18 further adjusts, limits, and otherwise changes the quantization parameter QP in accordance with the coding distortion information in response to the control signal from the coding distortion controller 28.

### <3. Operation of Adjusting Quantization Parameter>

Operation of adjusting the quantization parameter in accordance with the coding distortion information will next be described. The rate controller 18 sets the quantization parameter, for example, by using a code quantity control method set forth in TM5 in MPEG2. The rate control method set forth in TM5 in MPEG2 includes steps 1 to 3.

In step 1, the quantity of bit allocated to pictures in a GOP (group of pictures) is distributed to uncoded pictures including pictures to which bits will be allocated based on the quantity of allocated bit R. The distribution operation is repeated for each picture to be coded in the GOP. In this process, the quantity of code is allocated to each picture under two assumptions. A first assumption is that the product of an average quantizer scale code and a generated code quantity, which are used to code each picture, is fixed for each picture type unless the screen changes. A second assumption is that the overall image quality is typically optimized when ratios K_{P} and K_{B} of the quantizer scale codes for P and B pictures to the quantizer scale code for an I picture have the values represented by Expression (1).

Kₚ=1.0,K_{B}=1.4 (1)

In step 2, the quantizer scale codes are so determined that the quantity of bit allocated to the pictures (T₁, T_{P}, T_{B}) determined in step 1 agrees with the actual quantity of code. The quantizer scale codes are determined for the respective types of picture by performing feedback control on a macro-block basis based on three types of imaginary buffer capacity set independent from one another.

In step 3, the quantizer scale codes (quantization parameters) determined in step 2 are more finely quantized in a flat portion of an image where degradation is more visually recognized, whereas being more coarse in a complicated pattern in the image where degradation is less visually recognized. The quantization scale codes are thus changed in accordance with the activity in each macro-block.

The rate controller 18 corrects a quantization parameter QPorg determined for each macro-block in accordance with coding distortion information dq to determine a quantization parameter QP for the macro-block. The quantization parameter is determined, for example, by performing the computation expressed by Expression (2). In Expression (2), a is an arbitrary constant and determined in image quality adjustment.

QP=QPorg×α×dq (2)

As described above, in a decoded image generated by an image decoding apparatus, an effect of coding distortion produced in coding/decoding of a local decoded image can be reduced by adjusting the quantization parameter in accordance with the coding distortion information dq. For example, when the image quality of a local decoded image is degraded in coding/decoding processes, the amount of degradation in image quality of a decoded image generated by the image decoding apparatus can be reduced by adjusting the quantization parameter in such a way that a quantization step decreases, as compared with a case where no quantization parameter adjustment is made.

### <4. Operation of Limiting Quantization Parameter>

In operation of limiting the quantization parameter, the coding distortion controller 28 sets a range within which the quantization parameter is limited in accordance with the coding distortion information and sends a control signal to notify the rate controller 18 of the thus set limited range. Alternatively, the coding distortion controller 28 may send a control signal to notify the rate controller 18 of the coding distortion information, and the rate controller 18 may then set a range within which the quantization parameter is limited based on the notified coding distortion information. Further, when the quantization parameter is limited, information on the limited quantization parameter is supplied to the lossless coder 16.

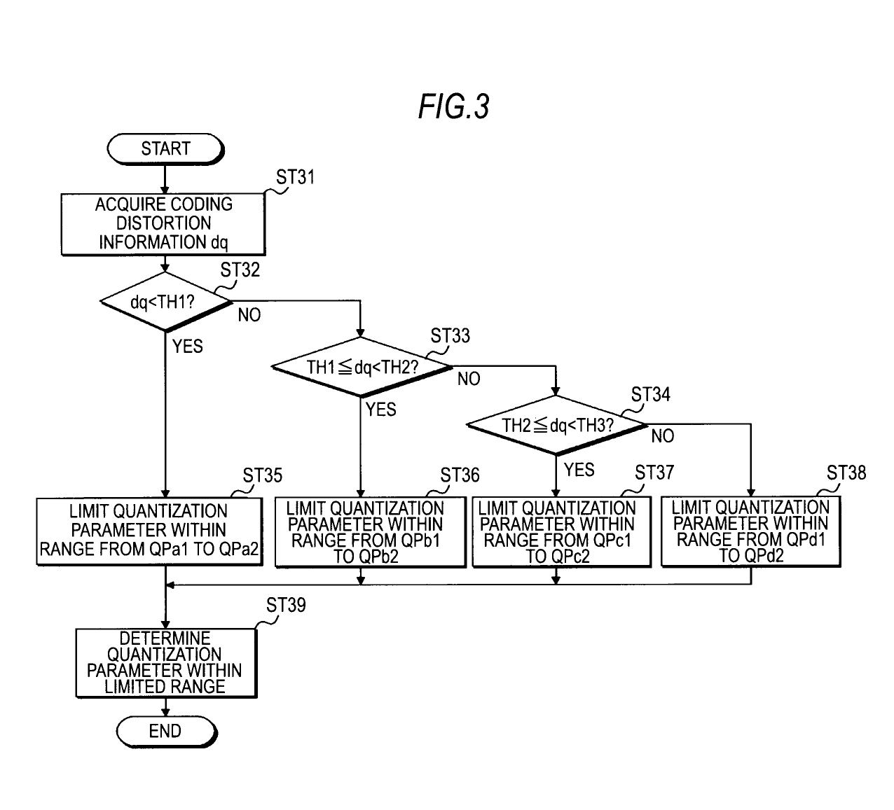

FIG. 3 is a flowchart showing the quantization parameter limiting operation performed by the coding distortion controller 28 and the rate controller 18. The quantization parameter per macro-block is determined by executing the procedure shown in FIG. 3. In the following description, the coding distortion controller 28 sets a range within which the quantization parameter is limited.

In step ST31, the coding distortion controller 28 acquires coding distortion information dq. The coding distortion controller 28 acquires coding distortion information corresponding to image data decoded by the local decoded image decoder 27 from the local decoded image decoder 27.

In step ST32, the coding distortion controller 28 judges whether the value of the coding distortion information dq is smaller than a threshold TH1. When the value of the coding distortion information dq is smaller than the threshold TH1, the coding distortion controller 28 proceeds to step ST35, whereas when the value of the coding distortion information dq is greater than or equal to the threshold TH1, the coding distortion controller 28 proceeds to step ST33.

In step ST33, the coding distortion controller 28 judges whether the value of the coding distortion information dq is greater than or equal to the threshold TH1 but smaller than a threshold TH2. When the value of the coding distortion information dq is greater than or equal to the threshold TH1 but smaller than the threshold TH2, the coding distortion controller 28 proceeds to step ST36, whereas when the value of the coding distortion information dq is greater than or equal to the threshold TH2, the coding distortion controller 28 proceeds to step ST34.

In step ST34, the coding distortion controller 28 judges whether the value of the coding distortion information dq is greater than or equal to the threshold TH2 but smaller than a threshold TH3. When the value of the coding distortion information dq is greater than or equal to the threshold TH2 but smaller than the threshold TH3, the coding distortion controller 28 proceeds to step ST37, whereas when the value of the coding distortion information dq is greater than or equal to the threshold TH3, the coding distortion controller 28 proceeds to step ST38.

In step ST35, the coding distortion controller 28 limits the quantization parameter within a range “from QPa1 to QPa2” and sends a control signal to notify the rate controller 18 of the limited range.

In step ST36, the coding distortion controller 28 limits the quantization parameter within a range “from QPb1 to QPb2” and sends a control signal to notify the rate controller 18 of the limited range.

In step ST37, the coding distortion controller 28 limits the quantization parameter within a range “from QPc1 to QPc2” and sends a control signal to notify the rate controller 18 of the limited range.

In step ST38, the coding distortion controller 28 limits the quantization parameter within a range “from QPd1 to QPd2” and sends a control signal to notify the rate controller 18 of the limited range.

In step ST39, the rate controller 18 determines the quantization parameter within the thus determined limited range. The rate controller 18 determines the quantization parameter within the quantization parameter limited range notified from the coding distortion controller 28 in such a way that a coded stream is outputted from the accumulation buffer 17 at a desired rate, and outputs the determined quantization parameter to the quantizer 15.

In the operation of limiting the quantization parameter, the upper and lower limits of the quantization parameter may not necessarily be defined as shown in FIG. 3, but only one of the upper and lower limits may alternatively be defined. For example, the amount of offset is set in accordance with the value of the coding distortion information dq or a result of comparison between the coding distortion information dq and any of the thresholds. The upper or lower limit of the quantization parameter can then be set by adding or subtracting the thus set amount of offset to or from the quantization parameter.

After the operation of limiting the quantization parameter is performed as described above, the lossless coder 16 uses the information on the limited quantization parameter to code quantization parameter information. When the range of the quantization parameter is limited, the length of a code of the quantization parameter information is shorter than in a case where the range of the quantization parameter is not limited. The efficiency at which the quantization parameter information is coded can be increased by limiting the range of the quantization parameter.

### <5. Other Operations of Reducing Effect of Coding Distortion>

In the above description, the quantization parameter is adjusted and limited in accordance with the coding distortion information dq. The effect of the coding distortion produced in the coding/decoding processes can alternatively be reduced by controlling the operation of the deblocking filter 24 and the predicted image/optimum mode selector 33 based on the coding distortion information.

The deblocking filter 24 adjusts the strength of the filtering in accordance with the coding distortion information in response to the control signal from the coding distortion controller 28, which will be described later (the same adjustment is made in ST19 shown in FIG. 2). For example, when a local decoded image is coded based on JPEG and the resultant coding distortion information shows that coding distortion is large, the strength of the filtering is so increased that high-frequency components at the boundary between blocks are attenuated by a greater amount. When the strength of the filtering is so set that high-frequency components are attenuated by a greater amount as described above, the degree of degradation in image quality produced in the coding/decoding processes can be reduced because the high-frequency components will be attenuated by a greater amount when a local decoded image of the following frame is coded.

Further, the predicted image/optimum mode selector 33 specifies an optimum mode based on the coding distortion information in response to the control signal from the coding distortion controller 28 (the same process is carried out in ST25 shown in FIG. 2). For example, when the image quality degradation produced in the coding/decoding processes is large, the difference between an image to be coded and a reference image becomes large, resulting in a decrease in coding efficiency. To prevent the coding efficiency from decreasing, intra-prediction is specified when the image quality degradation is expected to be large based on the coding distortion information.

As described above, in a decoded image generated by an image decoding apparatus, the effect of the coding distortion produced in the coding/decoding of a local decoded image can be reduced by adjusting the strength of the filtering of the deblocking filter 24 and selecting an predicted image in accordance with the coding distortion information dq.

Further, the image coding apparatus 10 may combine the operation of changing or limiting the quantization parameter, the operation of changing the strength of the filtering of the deblocking filter, and selecting the prediction mode based on the coding distortion information.

### <6. Configuration of Image Decoding Apparatus>

An image decoding apparatus that decodes a coded stream outputted from the image coding apparatus will next be described. The coded stream generated by coding input images is supplied to the image decoding apparatus via a predetermined transmission path, recording medium, or any other component and decoded by the image decoding apparatus.

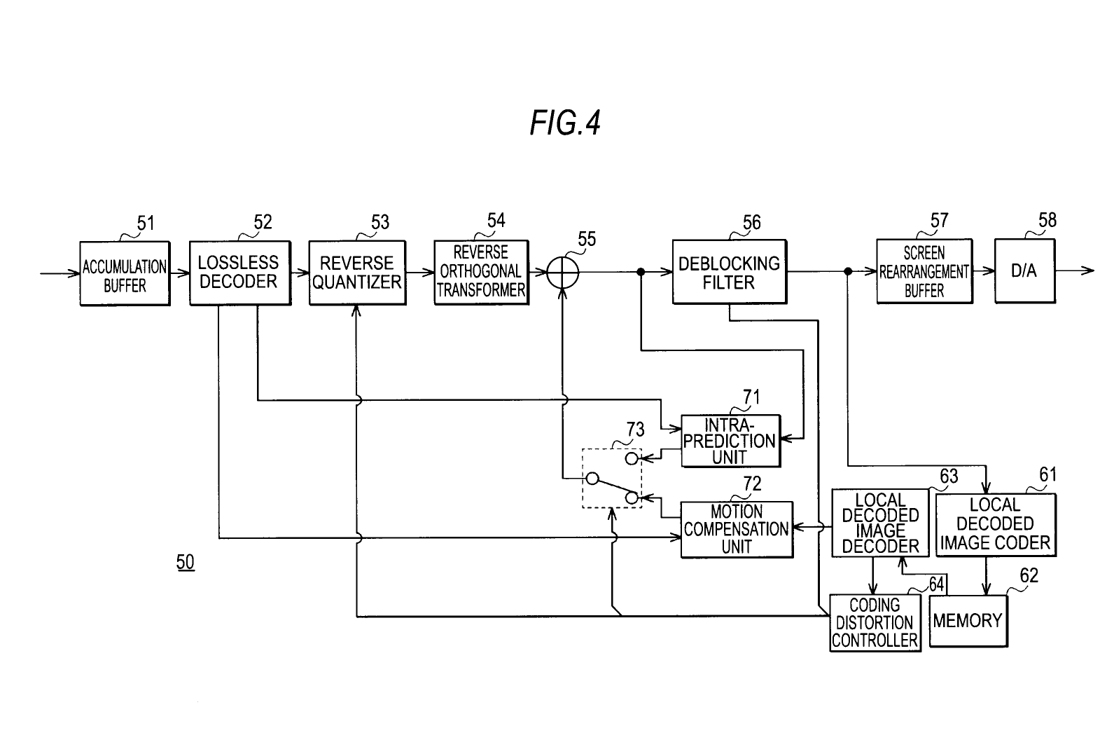

FIG. 4 shows the configuration of an image decoding apparatus that decodes a coded stream. An image decoding apparatus 50 includes an accumulation buffer 51, a lossless decoder 52, a reverse quantizer 53, a reverse orthogonal transformer 54, an adder 55, a deblocking filter 56, a screen rearrangement buffer 57, and a digital/analog converter (D/A converter) 58. The image decoding apparatus 50 further includes a local decoded image coder 61, a memory 62, a local decoded image decoder 63, and a coding distortion controller 64. The image decoding apparatus 50 still further includes an intra-prediction unit 71, a motion compensation unit 72, and a selector 73.

The accumulation buffer 51 accumulates a transmitted coded stream. The lossless decoder 52 decodes the coded stream supplied from the accumulation buffer 51 by using a method corresponding to the coding method used by the lossless coder 16 shown in FIG. 1.

The lossless decoder 52 operates as an information acquisition unit and acquires a variety of pieces of information from the coded stream. For example, the lossless decoder 52 decodes the coded stream and outputs the resultant predicted mode information and other pieces of information to the intra-prediction unit 71 and the motion compensation unit 72. The lossless decoder 52 further outputs quantization parameter information and quantized data obtained by decoding the coded stream to the reverse quantizer 53. When the range of the quantization parameter has been limited and the quantization parameter information has been coded, the lossless decoder 52 further uses a control signal supplied from the coding distortion controller 64, which will be described later, to decode the quantization parameter information.

The reverse quantizer 53 uses the quantization parameter to perform reverse quantization of the quantized data supplied from the lossless decoder 52 based on a method corresponding to the quantization method used by the quantizer 15 shown in FIG. 3. The reverse orthogonal transformer 54 performs reverse orthogonal transform of an output from the reverse quantizer 53 based on a method corresponding to the orthogonal transform performed by the orthogonal transformer 14 shown in FIG. 1 and outputs the resultant data to the adder 55.

The adder 55 adds the data having undergone the reverse orthogonal transform to predicted image data supplied from the selector 73 to generate image data on a decoded image and outputs the image data to the deblocking filter 56 and the intra-prediction unit 71.

The deblocking filter 56 performs filtering for reducing block distortion produced when an image is coded. The deblocking filter 56 filters the image data supplied from the adder 55 to remove block distortion from the image data and outputs the filtered image data to the screen rearrangement buffer 57 and the local decoded image coder 61. The deblocking filter 56 further adjusts the strength of the filtering in accordance with coding distortion information in response to a control signal from the coding distortion controller 64, which will be described later.

The screen rearrangement buffer 57 performs image rearrangement. That is, the screen rearrangement buffer 12 changes the order in which frames have been rearranged in the coding order by the screen rearrangement buffer 12 shown in FIG. 1 to the order in which the frames are rearranged in the original displaying order and outputs the rearranged image data to the D/A converter 58.

The D/A converter 58 D/A converts the image data supplied from the screen rearrangement buffer 57 and outputs the converted image data to a display (not shown), which displays decoded images.

The local decoded image coder 61 has the same configuration as that of the local decoded image coder 25 shown in FIG. 1. The local decoded image coder 61 uses the image data on the decoded image filtered by the deblocking filter 56 as image data on a local decoded image to code the image data based on lossy coding using high coding efficiency and outputs the coded image data to the memory 62. The local decoded image coder 61 further outputs the coding distortion information representing the degree of coding distortion to the memory 62. The amount of data to be stored in the memory 62 can be reduced by coding the coding distortion information in the local decoded image coder 61 before it outputs the coding distortion information to the memory 62. A Q number (quality number) is used as the coding distortion information when image data is coded based, for example, on JPEG (Joint Photographic Experts Group), as described above. When image data is coded based on bit plane coding, information on a bit disposal position is, for example, used as the coding distortion information.

The memory 62 holds the coded data and the coding distortion information corresponding thereto supplied from the local decoded image coder 61. The coded data and the coding distortion information corresponding thereto read from the memory 62 are outputted to the local decoded image decoder 63.

The local decoded image decoder 63 has the same configuration as that of the local decoded image decoder 27 shown in FIG. 1. The local decoded image decoder 63 decodes the coded data supplied from the memory 62 and supplies the motion compensator 72 with the resultant image data as reference image data. The local decoded image decoder 63 further outputs the coding distortion information read from the memory 62 to the coding distortion controller 64. When the coding distortion information has been coded, the local decoded image decoder 63 decodes the coding distortion information.

The coding distortion controller 64 has the same configuration as that of the coding distortion controller 28 shown in FIG. 1. The coding distortion controller 64 generates control signals for reducing the effect of the coding distortion produced in the coding/decoding of a local decoded image based on the coding distortion information and outputs the control signals to the deblocking filter 56 and the selector 73.

The intra-prediction unit 71 generates predicted image data based on the prediction mode information supplied from the lossless decoder 52 and the decoded image data supplied from the adder 55 and outputs the generated predicted image data to the selector 73.

The motion compensation unit 72 uses the image data supplied from the local decoded image decoder 63 to perform motion compensation based on the prediction mode information and motion vector information supplied from the lossless decoder 52 to generate predicted image data. The motion compensation unit 72 outputs the generated predicted image data to the selector 73.

The selector 73 chooses, based on the prediction mode information supplied from the lossless decoder 52, the intra-prediction unit 71 when the prediction mode is intra-prediction whereas choosing the motion compensation unit 72 when the prediction mode is inter-prediction. The selector 73 outputs the predicted image data generated by the thus chosen intra-prediction unit 71 or motion compensation unit 72 to the adder 55. Further, the selector 73 chooses the predicted image data from the intra-prediction unit 71 or the predicted image data from the motion compensation unit 72 based on the control signal from the coding distortion controller 64.

As described above, in the image decoding apparatus 50, the intra-prediction unit 71, the motion compensation unit 72, and the selector 73 generate a predicted image. Further, the generated predicted image and the coded stream are used to perform decoding in the reverse quantizer 21, the reverse orthogonal transformer 22, the adder 23, and the deblocking filter 24 for decode generation.

### <7. Operation of Image Decoding Apparatus>

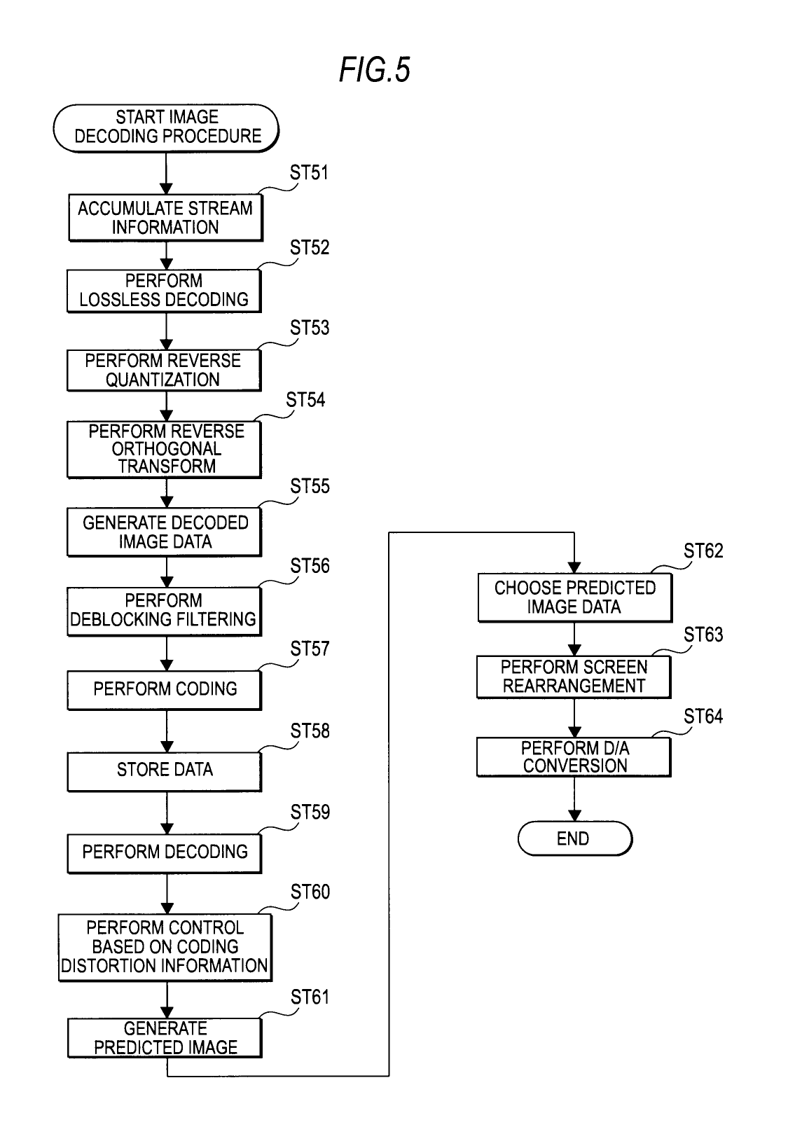

The operation of the image decoding apparatus 50 will next be described with reference to the flowchart shown in FIG. 5. In step ST51, the accumulation buffer 51 accumulates a supplied coded stream. In step ST52, the lossless decoder 52 performs lossless decoding. The lossless decoder 52 decodes the coded stream supplied from the accumulation buffer 51. That is, quantized data on each picture coded by the lossless coder 16 shown in FIG. 1 is generated. The lossless decoder further performs lossless decoding of prediction mode information and other information contained in the coded stream. When the resultant prediction mode information represents the intra-prediction mode, the lossless decoder 52 outputs the prediction mode information to the intra-prediction unit 71. When the resultant prediction mode information represents the inter-prediction mode, the lossless decoder 52 outputs the prediction mode information and motion vector information to the motion compensation unit 72.

In step ST53, the reverse quantizer 53 performs reverse quantization. The reverse quantizer 53 performs reverse quantization of the quantized data decoded by the lossless decoder 52 based on the characteristics corresponding to the characteristics of the quantizer 15 shown in FIG. 1.

In step ST54, the reverse orthogonal transformer 54 performs reverse orthogonal transform. The reverse orthogonal transformer 54 performs reverse orthogonal transform of transform coefficient data having undergone the reverse quantization in the reverse quantizer 53 based on the characteristics corresponding to the characteristics of the orthogonal transformer 14 shown in FIG. 1.

In step ST55, the adder 55 generates decoded image data. The adder 55 adds the data provided in the reverse orthogonal transform to predicted image data selected in step ST59, which will be described later, to generate decoded image data. The original image is thus decoded.

In step ST56, the deblocking filter 56 performs filtering. The deblocking filter 56 filters the decoded image data outputted from the adder 55 to remove block distortion.

In step ST57, the local decoded image coder 61 codes the image data filtered by the deblocking filter 56. The local decoded image coder 61, which has the same configuration of that of the local decoded image coder 25 in image coding apparatus 10, codes the image data based on a coding method using high coding efficiency and outputs the coded image data. The local decoded image coder 61 further generates coding distortion information representing the degree of coding distortion and outputs the coding distortion information.

In step ST58, the memory 62 stores the resultant data. The memory 62 stores the coded image data and the coding distortion information outputted from the local decoded image coder 61.

In step ST59, the local decoded image decoder 63 decodes the coded data read from the memory 62. The local decoded image decoder 63 further decodes the coding distortion information when the coding distortion information read from the memory 62 has been coded.

In step ST60, the coding distortion controller 64 performs control based on the coding distortion information. The coding distortion controller 64 generates control signals based on the coding distortion information and outputs the control signals to the lossless decoder 52, the deblocking filter 56, and the selector 73 to reduce an effect of the coding distortion produced in the coding/decoding processes.

In step ST61, the intra-prediction unit 71 and the motion compensation unit 72 generate predicted images. The intra-prediction unit 71 and the motion compensation unit 72 generate predicted images in correspondence with the prediction mode information supplied from the lossless decoder 52.

That is, when the lossless decoder 52 supplies prediction mode information containing intra-prediction, the intra-prediction unit 71 generates predicted image data based on the prediction mode information. When the lossless decoder 52 supplies prediction mode information containing inter-prediction, the motion compensation unit 72 performs motion compensation based on the prediction mode information and motion vector information to generate predicted image data.

In step ST62, the selector 73 performs predicted image data selection. The selector 73 chooses one of the predicted image data supplied from the intra-prediction unit 71 and the predicted image data supplied from the motion compensation unit 72, supplies the chosen predicted image data to the adder 55, which adds the supplied predicted image data to the output from the reverse orthogonal transformer 54 in step ST55, as described above. The selector 73 chooses the predicted image data supplied from the intra-prediction unit 71 based on the control signal from the coding distortion controller 64 when the coding/decoding processes produce large degradation in image quality.

In step ST63, the screen rearrangement buffer 57 performs image rearrangement. That is, the screen rearrangement buffer 57 changes the order in which frames have been rearranged in the coding order by the screen rearrangement buffer 12 in the image coding apparatus 10 shown in FIG. 1 to the order in which the frames are rearranged in the original displaying order.

In step ST64, the D/A converter 58 D/A converts the image data from the screen rearrangement buffer 57 and outputs the converted image data to a display (not shown), which displays corresponding images.

<8. Decoding Operation Performed when Quantization Parameter is Limited>

Even when the efficiency at which quantization parameter information is coded is increased in the image coding apparatus 10 by limiting the range of the quantization parameter, the image decoding apparatus 50 correctly decodes the quantization parameter information from a coded stream.

The coding distortion controller 64 in the image decoding apparatus 50 performs the same process performed by the coding distortion controller 28 in the image coding apparatus 10 to limit the range of the quantization parameter in accordance with the coding distortion information as in the image coding process. The coding distortion controller 64 further outputs information on the limited quantization parameter to the lossless decoder 52.

The lossless decoder 52 uses the information on the limited quantization parameter supplied from the coding distortion controller 64 to perform decoding corresponding to the coding performed by the lossless coder 16 to generate the quantization parameter information from the coded stream.

As described above, the coding distortion controller 64 generates information on the limitation of the quantization parameter used when the quantization parameter has been coded and supplies the generated information to the lossless decoder 52, which can then correctly generate quantization parameter information from the coded stream. That is, since the image decoding apparatus 50 can correctly generate quantization parameter information from the coded stream by limiting the range of the quantization parameter even when the efficiency at which the quantization parameter information is coded is increased at the time of image coding, a high-quality decoded image can be provided.

<9. Decoding Operation Performed when Effect of Coding Distortion is Reduced at the Time of Coding>

The image decoding apparatus 50 adjusts and limits the quantization parameter in accordance with the coding distortion information dq in the above description. Alternatively, the image decoding apparatus 50 can reduce the effect of coding distortion produced in the coding/decoding processes by controlling the operation of the deblocking filter 24 and the predicted image/optimum mode selector 33 based on the coding distortion information.

The deblocking filter 24 adjusts the strength of the filtering in accordance with the coding distortion information in response to the control signal from the coding distortion controller 28 (the same adjustment is made in ST19 shown in FIG. 2). For example, when a local decoded image is coded based on JPEG and the resultant coding distortion information shows that coding distortion is large, the strength of the filtering is so increased that high-frequency components at the boundary between blocks are attenuated by a greater amount. When the strength of the filtering is so set that high-frequency components are attenuated by a greater amount as described above, the degree of degradation in image quality produced in the coding/decoding processes can be reduced because the high-frequency components will be attenuated by a greater amount when a local decoded image of the following frame is coded.

Further, the predicted image/optimum mode selector 33 specifies an optimum mode based on the coding distortion information in response to the control signal from the coding distortion controller 28 (the same process is carried out in ST25 shown in FIG. 2). For example, when the image quality degradation produced in the coding/decoding processes is large, the difference between an image to be coded and a reference image becomes large, resulting in a decrease in coding efficiency. To prevent the coding efficiency from decreasing, intra-prediction is specified (the same process is carried out in ST25 shown in FIG. 2) when the image quality degradation is expected to be large based on the coding distortion information.

Further, the local decoded image coder 25 in the image coding apparatus 10 and the local decoded image coder 61 in the image decoding apparatus 50 are so set that coding is performed at the same coding rate, and the image decoding apparatus 50 performs coding/decoding of a local decoded image, adjusts and limits the quantization parameter in according with the coding distortion information, adjust the strength of the filtering of the deblocking filter, and switches the prediction mode in the same manner as the image coding apparatus 10 does. Further, when the image coding and the image decoding are performed in the same manner, it is not necessary to add information used to control the quantization parameter, the deblocking filter, and the prediction mode in accordance with the coding distortion information to a coded stream, whereby the coding efficiency can be improved.

Further, the image decoding apparatus 50 may combine the operation of changing or limiting the quantization parameter, the operation of changing the strength of the filtering of the deblocking filter, and the operation of selecting the prediction mode based on the coding distortion information. When the combination is the same as in the image coding apparatus 10, input images can be coded and decoded in the image coding apparatus and the image decoding apparatus under the same rule.

### <10. Using Software Processing>

The series of processes described in the specification can be carried out by hardware, software, or the combination thereof. To perform the processes by software, a program in which the process sequence is recorded is installed in a memory in a computer incorporated into dedicated hardware and then executed, or the program is installed in a general-purpose computer capable of executing a variety of processes and then executed.

For example, the program can be recorded in advance on a recording medium, such as a hard disc drive and a ROM (read only memory). The program can alternatively be temporarily or permanently stored (recorded) on a flexible disc, a CD-ROM (compact disc read only memory), an MO (magneto-optical) disc, a DVD (digital versatile disc), a magnetic disc, a semiconductor memory card, and other removable recording media. What is called packaged software can be provided in the form of any of the removable recording media.

The program may be installed from a removable recording medium onto a computer, or the program may be transmitted from a download site over a LAN (local area network), the Internet, or any other suitable network to a computer in a wireless or wired manner. The computer receives the thus transmitted program, which is then installed on a built-in hard disk drive or any other suitable recording medium.

The present technology should not be construed as limited to the embodiment described above. The present technology is disclosed in the form of an embodiment thereof by way of example, and it is obvious that the skilled in the art can modify and substitute the embodiment to the extent that the modification and the substitution do not depart from the spirit of the present technology. That is, to understand the spirit of the present technology, the appended claims should be referred to.

The present technology can also be configured as follows.

(1) An image coding apparatus including

a coding processor that codes an image representing a difference between an input image and a predicted image to generate coded data,

a decoding processor that decodes the coded data to generate a local decoded image,

a local decoded image coder that codes the local decoded image and stores the coded local decoded image in a memory,

a local decoded image decoder that decodes the local decoded image coded and stored in the memory, and

a controller that controls the generation of the coded data in accordance with coding distortion information representing the degree of coding distortion produced in the coding/decoding of the local decoded image.

(2) The image coding apparatus described in (1),

wherein the controller adjusts a quantization parameter used to code the difference image in accordance with the coding distortion information.

(3) The image coding apparatus described in (1) or (2),

wherein the controller limits the range of the quantization parameter used to code the difference image in accordance with the coding distortion information, and the coding processor uses the limited range to code the quantization parameter.

(4) The image coding apparatus described in any of (1) to (3),

further including a deblocking filter that filters the local decoded image,

wherein the controller changes strength of the filtering of the deblocking filter in accordance with the coding distortion information.

(5) The image coding apparatus described in any of (1) to (4),

wherein the coding processor uses the decoded local decoded image to generate an intra-prediction image and an inter-prediction image, and

the controller chooses the intra-prediction image or the inter-prediction image in accordance with the coding distortion information and uses the chosen image as the predicted image.

(6) An image decoding apparatus including

a decoding processor that decodes a coded stream to generate a difference image and adds a predicted image to the difference image to generate a decoded image,

a local decoded image coder that codes the decoded image as a local decoded image and stores the local decoded image in a memory,

a local decoded image decoder that decodes the local decoded image coded and stored in the memory, and

a controller that controls the generation of the difference image or the predicted image in accordance with coding distortion information representing the degree of coding distortion produced in the coding/decoding of the local decoded image.

(7) The image decoding apparatus described in (6),

wherein the controller limits the range of a quantization parameter in accordance with the coding distortion information, and

the decoding processor uses the limited range to decode the quantization parameter coded and added to the coded stream and uses the resultant quantization parameter to decode the coded stream to generate a difference image.

(8) The image decoding apparatus described in (6) or (7),

further including a deblocking filter that filters the local decoded image,

wherein the controller changes strength of the filtering of the deblocking filter in accordance with the coding distortion information.

(9) The image decoding apparatus described in any of (6) to (8),

wherein the decoding processor uses the decoded local decoded image to generate an intra-prediction image and an inter-prediction image, and

the controller chooses the intra-prediction image or the inter-prediction image in accordance with the coding distortion information and uses the chosen image as the predicted image.

According to the image coding apparatus, the image decoding apparatus, the image coding method, the image decoding method, and the program of the embodiments of the present technology, at the time of coding, coded data generated by coding information on the difference between an input image and a predicted image is decoded to generate a local decoded image. The local decoded image is coded and stored in a memory and then read and decoded. The generation of the coded data is controlled in accordance with coding distortion produced in the coding/decoding of the local decoded image to reduce an effect of the coding distortion. Further, when a coded stream is decoded, a decoded image generated in the decoding process is coded as a local decoded image and stored in a memory, and then read and decoded. The generation of the decoded image is also controlled in accordance with the coding distortion produced in the coding/decoding of the local decoded image, as in the coding process. A high-quality decoded image can therefore be provided at the time of decoding even when coding efficiency is increased when a local decoded image is stored. The image coding apparatus and the image decoding apparatus are suitable for an electronic system that records, reproduces, edits, and otherwise processes video images.

The present disclosure contains subject matter related to that disclosed in Japanese Priority Patent Application JP 2011-127183 filed in the Japan Patent Office on Jun. 7, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image coding apparatus comprising:
a coding processor that codes an image representing a difference between an input image and a predicted image to generate coded data;
a decoding processor that decodes the coded data to generate a local decoded image;
a local decoded image coder that codes the local decoded image and stores the coded local decoded image in a memory;
a local decoded image decoder that decodes the local decoded image coded and stored in the memory; and
a controller that controls the generation of the coded data in accordance with coding distortion information representing the degree of coding distortion produced in the coding/decoding of the local decoded image.

2. The image coding apparatus according to claim 1,
wherein the controller adjusts a quantization parameter used to code the difference image in accordance with the coding distortion information.

3. The image coding apparatus according to claim 1,
wherein the controller limits the range of the quantization parameter used to code the difference image in accordance with the coding distortion information, and
the coding processor uses the limited range to code the quantization parameter.

4. The image coding apparatus according to claim 1,
further comprising a deblocking filter that filters the local decoded image,
wherein the controller changes strength of the filtering of the deblocking filter in accordance with the coding distortion information.

5. The image coding apparatus according to claim 1,
wherein the coding processor uses the decoded local decoded image to generate an intra-prediction image and an inter-prediction image, and
the controller chooses the intra-prediction image or the inter-prediction image in accordance with the coding distortion information and uses the chosen image as the predicted image.

6. An image coding method comprising:
coding an image representing a difference between an input image and a predicted image to generate coded data;
decoding the coded data to generate a local decoded image;
coding the local decoded image and storing the coded local decoded image in a memory;
decoding the local decoded image coded and stored in the memory; and
controlling the generation of the coded data in accordance with coding distortion information representing the degree of coding distortion produced in the coding/decoding of the local decoded image.

7. A program that instructs a computer to execute:
coding an image representing a difference between an input image and a predicted image to generate coded data;
decoding the coded data to generate a local decoded image;
coding the local decoded image and storing the coded local decoded image in a memory;
decoding the local decoded image coded and stored in the memory; and
controlling the generation of the coded data in accordance with coding distortion information representing the degree of coding distortion produced in the coding/decoding of the local decoded image.

8. An image decoding apparatus comprising:
a decoding processor that decodes a coded stream to generate a difference image and adds a predicted image to the difference image to generate a decoded image;
a local decoded image coder that codes the decoded image as a local decoded image and stores the local decoded image in a memory;
a local decoded image decoder that decodes the local decoded image coded and stored in the memory; and
a controller that controls the generation of the difference image or the predicted image in accordance with coding distortion information representing the degree of coding distortion produced in the coding/decoding of the local decoded image.

9. The image decoding apparatus according to claim 8,
wherein the controller limits the range of a quantization parameter in accordance with the coding distortion information, and
the decoding processor uses the limited range to decode the quantization parameter coded and added to the coded stream and uses the resultant quantization parameter to decode the coded stream to generate a difference image.

10. The image decoding apparatus according to claim 8,
further comprising a deblocking filter that filters the local decoded image,
wherein the controller changes strength of the filtering of the deblocking filter in accordance with the coding distortion information.

11. The image decoding apparatus according to claim 8,
wherein the decoding processor uses the decoded local decoded image to generate an intra-prediction image and an inter-prediction image, and
the controller chooses the intra-prediction image or the inter-prediction image in accordance with the coding distortion information and uses the chosen image as the predicted image.

12. An image decoding method comprising:
decoding a coded stream to generate a difference image and adding a predicted image to the difference image to generate a decoded image;
coding the decoded image as a local decoded image and storing the local decoded image in a memory;
decoding the local decoded image coded and stored in the memory; and
controlling the generation of the difference image or the predicted image in accordance with coding distortion information representing the degree of coding distortion produced in the coding/decoding of the local decoded image.

13. A program that instructs a computer to execute:
decoding a coded stream to generate a difference image and adding a predicted image to the difference image to generate a decoded image;
coding the decoded image as a local decoded image and storing the local decoded image in a memory;
decoding the local decoded image coded and stored in the memory; and
controlling the generation of the difference image or the predicted image in accordance with coding distortion information representing the degree of coding distortion produced in the coding/decoding of the local decoded image.
